(19) United States
(12) Patent Application Publication
(10) Pub. No.: US 2021/0131045 A1
(43) Pub. Date: May 6, 2021

(54) CONTROL SYSTEM AND METHOD FOR OPERATING A SCREED ASSEMBLY

(71) Applicant: Caterpillar Paving Products Inc., Brooklyn Park, MN (US)

(72) Inventor: Chad M. Thiesse, Brooklyn Park, MN (US)

(73) Assignee: Caterpillar Paving Products Inc., Brooklyn Park, MN (US)

(21) Appl. No.: 16/669,677

(22) Filed: Oct. 31, 2019

(51) Int. Cl. E01C 19/48; G08C 17/02; E01C 19/00; E01C 23/01

(52) U.S. Cl. CPC E01C 19/48; G08C 17/02; G05D 2201/0202; E01C 23/01; E01C 19/004

(57) ABSTRACT

A control system for operating a screed assembly of a paving machine is provided. The control system includes a first sensor, a second sensor and a controller. The first sensor is positioned in proximity to the screed assembly and includes a first transceiver. The first sensor is configured to determine a first position parameter of the screed assembly. The second sensor is also positioned in proximity to the screed assembly and includes a second transceiver. The second sensor is configured to determine a second position parameter of the screed assembly. The controller includes a third transceiver for wirelessly communicating with the first transceiver and the second transceiver. The controller is configured to wirelessly receive the first position parameter and the second position parameter and accordingly control a position of the screed assembly based on one or more of the received first and the second position parameters.

### TECHNICAL FIELD

The present disclosure generally relates to a screed assembly for a paving machine. More particularly, the present disclosure relates to a control system and method for operating the screed assembly.

### BACKGROUND

Paving machines are commonly known to use asphalt material for the purposes of laying or forming hard surface roads. Generally, these paving machines include an operator station for permitting an on-board operator to ensure that the asphalt material is properly placed (in the form of a mat), and that the resulting road surface is properly laid. The asphalt material is leveled and compacted by a screed assembly located at a rear of the paving machine. Since, a paving machine often operates on an uneven surface, it is important to maintain proper thickness or grade and slope of the mat to obtain an evenly laid resultant road surface.

Typically, one or more grade sensors and slope sensors are positioned on the paving machine, such as on the screed assembly, to monitor an elevation and inclination of the screed assembly to maintain a desired thickness and slope of the mat being laid. Any changes in either of these position parameters of the screed assembly is detected by these sensors and communicated to a controller, which in turn adjusts the screed assembly to maintain the proper elevation and inclination during the paving operation.

Generally, the grade sensors and the slope sensors are connected, using a wiring harness, into electrical ports that are often positioned either on the rear end of the machine or near the screed assembly. The wiring harness is long enough to accommodate the screed's varying widths during operation. When the screed assembly extends or retracts, the wiring harness may get damaged by getting tangled or pinched in between the screed assembly components, which is not desirable. Further, the wiring harness tends to get in the way for paver operators and obstruct access to the other areas of the paving machine, which is again not desirable.

U.S. Pat. No. 8,469,630 (hereinafter referred to as the '630 patent) provides a sensor system for road construction equipment. The system includes a first conveyor for transporting material to a first auger that is positioned to receive the material. A first feeder sensor associated with the first conveyor is in over-the-air communication with a receiver to communicate the height of a material on the conveyor such that a master controller that is electrically connected to the receiver can regulate the amount of flow of material to the first conveyor.

### SUMMARY OF THE INVENTION

In an aspect of the present disclosure, a control system for operating a screed assembly of a paving machine is provided. The control system includes a first sensor, a second sensor and a controller. The first sensor is positioned in proximity to the screed assembly and includes a first transceiver. The first sensor is configured to determine a first position parameter of the screed assembly. The second sensor is also positioned in proximity to the screed assembly and includes a second transceiver. The second sensor is configured to determine a second position parameter of the screed assembly. The controller includes a third transceiver for wirelessly communicating with the first transceiver and the second transceiver. The controller is configured to wirelessly receive the first position parameter and the second position parameter and accordingly control a position of the screed assembly based on one or more of the received first and the second position parameters.

In another aspect of the present disclosure, a method for operating the screed assembly of a paving machine is provided. The method includes determining a first position parameter of the screed assembly by a first sensor positioned in proximity to the screed assembly. The method further includes determining a second position parameter of the screed assembly by the second sensor positioned in proximity to the screed assembly. Furthermore, the method includes receiving wirelessly, by a transceiver of a controller, the one or more of the first position parameter and the second position parameter from a first transceiver of the first sensor and a second transceiver of the second sensor. The method then includes controlling, by the controller, a position of the screed assembly based on the received first and the second position parameter.

In a yet another aspect of the present disclosure, a paving machine is provided. The paving machine includes a screed assembly for spreading and compacting paving material over a paving surface. The machine further includes a control system for operating the screed assembly of the paving machine. The control system includes a first sensor, a second sensor and a controller. The first sensor is positioned in proximity to the screed assembly and includes a first transceiver. The first sensor is configured to determine a first position parameter of the screed assembly. The second sensor is also positioned in proximity to the screed assembly and includes a second transceiver. The second sensor is configured to determine a second position parameter of the screed assembly. The controller includes a third transceiver for wirelessly communicating with the first transceiver and the second transceiver. The controller is configured to wirelessly receive the first position parameter and the second position parameter and accordingly control a position of the screed assembly based on one or more of the received first and the second position parameters.

### BRIEF DESCRIPTION OF THE DRAWINGS

FIG. 1 illustrates an exemplary paving machine operating on a paving surface, in accordance with embodiments of the present disclosure;

FIG. 2 illustrates a side view of the paving machine operating at the paving surface, in accordance with the embodiments of the present disclosure;

FIG. 3 illustrates a rear view of the paving machine operating at the paving surface, in accordance with the embodiments of the present disclosure;

FIG. 4 illustrates an exemplary control system for operating a screed assembly of the paving machine, in accordance with the embodiments of the present disclosure; and

FIG. 5 illustrates an exemplary method of operating the screed assembly of the paving machine, in accordance with the embodiments of the present disclosure.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

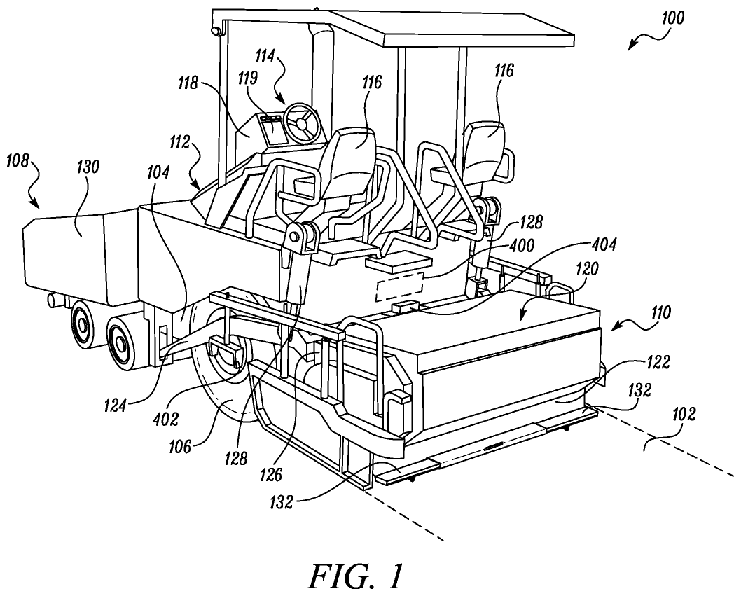

The present disclosure relates to a control system for operating a screed assembly of a paving machine. FIGS. 1 to 3 illustrate an exemplary paving machine 100 in accordance with the various embodiments of the present disclosure. The paving machine 100 may be an asphalt paver or any other machine used to distribute a layer of paving material on a paving surface 102.

The machine 100 includes a frame 104 with a set of ground engaging members 106, such as wheels or tracks, coupled with the frame 104. The frame 104 includes a front portion 108 and a rear portion 110. The machine 100 further includes a tractor portion 112 supported on the frame 104. The tractor portion 112 includes a power source (not shown) and an operator station 114. The power source may be an engine, such as an internal combustion engine, configured to power operations of various systems on the machine 100, such as the ground engaging members 106. The operator station 114 includes an operator seat 116 and a console 118, that may include various controls for directing operations of the machine 100. For example, the console 118 may include an Input/Output unit 119 including, but not limited to, one or more touch screens, joysticks, switches etc., to facilitate an operator in operating the machine 100 and the components of the machine 100, such as the screed assembly 120.

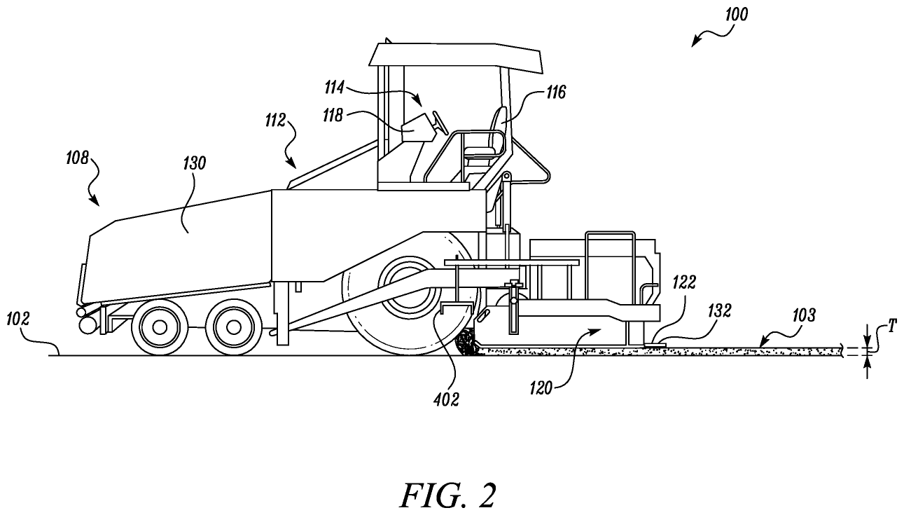

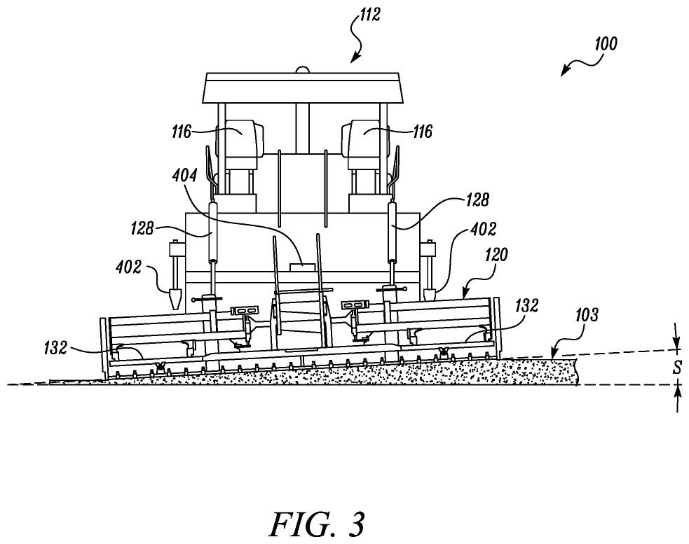

The machine 100 includes a screed assembly 120 configured to spread and compact paving material into a layer or mat 103 of a desired thickness, size and uniformity on the paving surface 102. In an exemplary embodiment, the screed assembly 120 includes a free-floating or a self-levelling screed 122 coupled to the machine 100, via tow arms 124, at a drop arm 126 of the screed assembly 120. The screed assembly 120, and more particularly the screed 122, may be raised or lowered by raising or lowering the tow arms 124 via one or more tow arm cylinders 128. The tow arm cylinders 128 may be hydraulically or pneumatically operated to raise and/or lower the screed assembly 120. For example, a desired grade (or thickness) and slope of the mat 103 may be obtained by adjusting a height and inclination/tilt, respectively, of the screed 122. In an example, a height/elevation of the screed 122 with respect to the paving surface 102 may define a thickness T of the mat 103 being laid, as shown in FIG. 2. This means, greater the height/elevation of the screed 122, higher may be the thickness T of the mat 103. Further, in order to obtain a smooth surface of the mat 103, an inclination/tilt of the screed 122 (as shown in FIG. 3) may be maintained to obtain a desired slope S (transverse to the direction of paving) of the mat 103 to be laid on an uneven and/or inclined/sloping terrain of the paving surface 102.

The machine 100 further includes a hopper 130 supported on the front portion 108 of the frame 104 and configured to receive and store the paving material. A conveyor system having one or more conveyors (not shown) is further configured to move the paving material from the hopper 130 to the screed assembly 120. In one example, the screed assembly 120 may be capable of extending to allow for wider paving applications and may include a screed extender having an extender plate 132 to widen and narrow, as required, to lay the appropriate width of the mat 103 for a particular paving job.

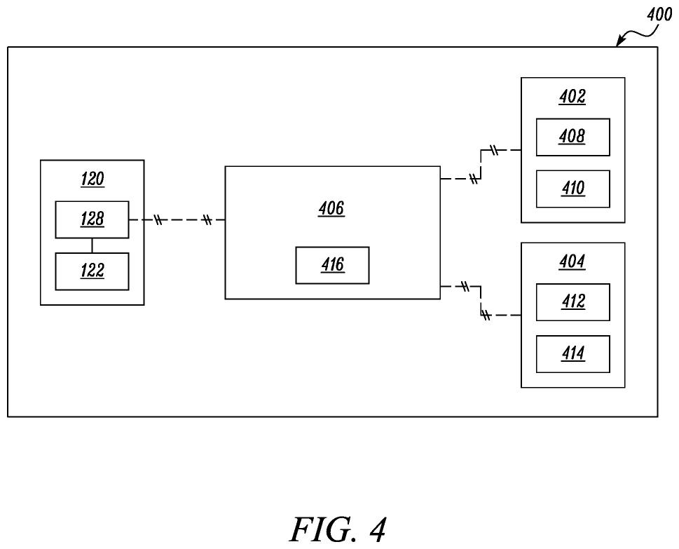

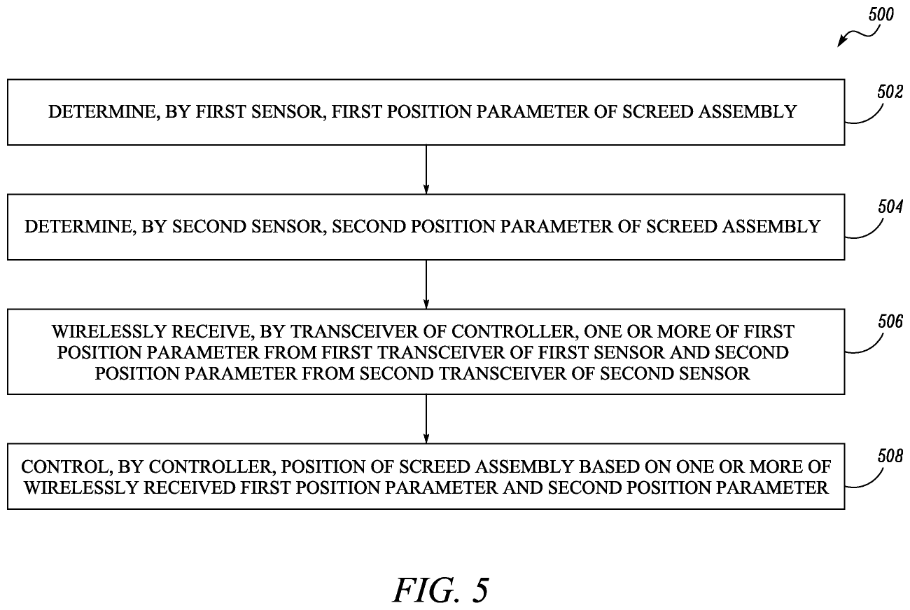

In an embodiment of the present disclosure, the machine 100 includes a control system 400 for operating the screed assembly 120. For example, the control system 400 may be configured to adjust one or more position parameters, such as height and inclination, of the screed assembly 120 to control the grade/thickness T and slope S of the mat 103 being laid on the paving surface 102. The details of the control system 400 are further described in the following description with reference to FIGS. 4 to 5.

FIG. 4 illustrates the exemplary control system 400 for operating the screed assembly 120. The control system 400 includes a first sensor 402, a second sensor 404, and a controller 406 communicatively coupled to each of the first sensor 402 and the second sensor 404. The control system 400 is configured to send control signals to the tow arm cylinders 128 for operating the screed 122 of the screed assembly 120 during the paving operations.

The first sensor 402 and the second sensor 404 are each positioned in proximity to the screed 122 of the screed assembly 120 and configured to monitor one or more position parameters of the screed assembly 120. In an embodiment of the present disclosure, the monitored position parameters (i.e., data related to the monitored position parameters) are wirelessly transmitted to the controller 406, which in turn controls the tow arm cylinders 128 for adjusting the position of the screed 122.

The first sensor 402 is configured to determine a first position parameter of the screed assembly 120 and wirelessly transmit the determined first position parameter to the controller 406. In an exemplary embodiment, the first sensor 402 is a wireless grade sensor, hereinafter interchangeably referred to as the wireless grade sensor 402, positioned on the tow arm 124 of the screed assembly 120, as shown in FIGS. 1 and 2. In one example, the wireless grade sensor 402 is a non-contact ultrasonic grade sensor including a first transducer 408, such as an ultrasonic transducer, configured to generate pulses and receive echo of each pulse to determine a distance of the mat 103 from the first sensor 402. The distance of the mat 103 from the first sensor 402 indicates the elevation/height H of the screed 122 from the paving surface 102, which in turn defines the thickness T of the mat 103.

In an example, the first sensor 402 may be calibrated according to a desired thickness T of the mat 103. Accordingly, the first sensor 402 may initially determine the distance of the mat 103 and store it as a reference value. Further, during operation, when the screed 122 starts to rise, the first transducer 408 of the first sensor 402 may detect the increase in travelling time of the echo pulse as compared to the reference value and accordingly detect a change in height/elevation of the screed 122 with respect to the paving surface 102.

Further, the wireless grade sensor 402 includes a first transceiver 410 configured to wirelessly communicate with and transmit data to the controller 406. For example, the first transceiver 410 receives the determined first position parameter, i.e., the elevation/height and/or the change in elevation/height of the screed 122 from the first transducer 408 and wirelessly transmits the same to the controller 406. Although, the first sensor 402 is described to be an ultrasonic grade sensor, it may be contemplated by a person skilled in the art that any other type of wireless grade sensor can be used to achieve similar functionalities, without deviating from the scope of the claimed subject matter.

In an embodiment, the second sensor 404 is configured to determine a second position parameter of the screed assembly 120 and wirelessly transmit the determined second position parameter to the controller 406. In one example, the second sensor 404 is a wireless slope sensor, hereinafter interchangeably referred to as the wireless slope sensor 404, positioned on a transverse beam of the screed 122, as shown in FIG. 1. The wireless slope sensor 404 is configured to determine an inclination of the screed assembly 120, more particularly the screed 122, with respect to the paving surface 102, as shown in FIG. 3, thereby indicating the slope S of the mat 103 being laid. As explained above, the slope S is measured transverse to the direction of travel of the paving machine 100.

In one example, the wireless slope sensor 404 is a dual port slope sensor including a second transducer 412, such as a tilt sensor or inclinometer, configured to measure a tilt/inclination of the screed 122 with respect to the paving surface 102. The wireless slope sensor 404 is configured to produce an electrical signal that varies with its angular movement, thereby indicating a slope or inclination within a limited range of motion of the screed 122. Such tilt sensors are commonly known in the art and hence, are not described herein detail for the sake of brevity of the disclosure.

Furthermore, the wireless slope sensor 404 includes a second transceiver 414 configured to wirelessly communicate with and transmit data to the controller 406. For example, the second transceiver 414 receives the determined second position parameter, i.e., the slope/inclination of the screed 122 from the second transducer 412 and wirelessly transmits the same to the controller 406. Although, the second sensor 404 is described to be a wireless slope sensor having a tilt sensor, it may be contemplated by a person skilled in the art that any other type of wireless slope sensor can be used to achieve similar functionalities, without deviating from the scope of the claimed subject matter.

In an embodiment of the present disclosure, the controller 406 includes a third transceiver 416 capable of wirelessly communicating with each of the first transceiver 410 of the first sensor 402 and the second transceiver 414 of the second sensor 404. The controller 406 is configured to receive the first position parameter from the first sensor 402 and the second position parameter from the second sensor 404 and control the position of the screed assembly 120 accordingly.

For example, during operation, in order to maintain a consistent thickness T and slope S of the mat 103, the elevation and inclination of the screed 122 needs to be maintained constant at all times. Since the screed 122 is a free-floating type, when it operates at a site with uneven and/or inclined paving surface 102, the one or more of elevation and/or the inclination of the screed 122 may change, thereby impacting the thickness T and slope S of the mat 103.

To this end, as soon as the first transducer 408 detects a change in elevation of the screed 122, the first transceiver 410 transmits the detected new elevation to the third transceiver 416 of the controller 406. Based on the changed elevation, the controller 406 sends a control signal to regulate the tow arm cylinders 128 for adjusting the position of the tow arms 124, thereby adjusting the elevation of the screed 122 until the first sensor 402 reports a correct elevation of the screed 122.

In an alternative embodiment, as and when required, the third transceiver 416 of the controller 406 wirelessly transmits a signal to the first transceiver 410 of the first sensor 402 to monitor the height/elevation of the screed 122 with respect to the paving surface 102. The controller 406 is further configured to compare the received elevation with a first reference value and detect a change in the elevation/height of the screed 122. The first reference value may be predefined and correspond to the desired thickness T of the mat 103 to be laid on the paving surface 102. Accordingly, when the controller 406 detects the change or deviation in the elevation/height of the screed 122 during operation, it sends a control signal to the tow arm cylinders 128 for adjusting the position of the tow arms 124, thereby adjusting the elevation of the screed 122 until the first sensor 402 reports the correct elevation of the screed 122 again.

In a further embodiment of the present disclosure, the second sensor 404 may be preset according to the desired slope S of the mat 103. During operation, the wireless slope sensor 404 may detect a change in inclination of the screed 122 and wirelessly communicates the detected changed inclination to the third transceiver 416 of the controller 406. For example, the electrical signal produced by the second transducer 412 may change or vary to indicate the change in inclination of the screed 122. The updated reading of the electrical signal generated by the second transducer 412 is wirelessly transmitted by the second transceiver 414 to the third transceiver 416 of the controller 406 for further processing.

Based on the updated reading received from the second sensor 404, the controller 406 controls the tow arm cylinders 128 for adjusting the position of the tow arms 124 to further adjust the inclination of the screed 122. For example, the controller 406 may raise or lower the tow arm cylinders 128 until the second sensor 404 obtains the correct inclination of the screed 122 as desired to maintain the slope S of the mat 103.

It may be contemplated by a person skilled in the art, that the controller 406 may also communicate with the first sensor 402 and the second sensor 404 to control the position of the screed 122 to vary the thickness T and the slope S of the mat 103, as and when required. For example, for different paving operations, the desired mat thickness and slope may be different and the controller 406 may accordingly receive inputs from the first sensor 402 and the second sensor 404 to adjust the position of the screed 122 for such different mat thickness and slope.

Although, the transceivers and transducers are shown and described as separate components, it may be well contemplated by a person skilled in the art that they may be combined into a single unit/device to perform similar functionalities, without deviating from the scope of the claimed subject matter.

According to various embodiments of the present disclosure, the first transceiver 410 of the first sensor 402, the second transceiver 414 of the second sensor 404 and the third transceiver 416 of the controller 406 are configured communicate wirelessly over one or more of wireless radio links, infrared communication links, short wavelength Ultra-high frequency radio waves, short-range high frequency waves, or the like. Example transceivers may include, but not limited to, wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

### INDUSTRIAL APPLICABILITY

The control system 400 of the present disclosure operates on wireless communication technology by establishing wireless communication between the sensors 402, 404 and the controller 406 for operating the screed assembly 120 and further controlling grade and slope of the mat 103 being laid on the paving surface 102. As the sensors 402, 404 communicate wirelessly with the controller 406, the need for conventional wiring harness is eliminated. Thus, the area around the screed 122 is also clutter free, allowing an operator to operate the machine 100 with relative ease and access other components of the machine 100, during the paving operations.

FIG. 5 illustrates an exemplary method 500 for operating the screed assembly 120, in accordance with the embodiments of the present disclosure.

During operation of the paving machine 100, at step 502, a first position parameter, of the screed assembly 120 is determined by the first sensor 402 positioned in proximity to the screed assembly 120. In one embodiment, the first sensor 402 is a wireless grade sensor for determining the elevation or height of the screed 122 with respect to the paving surface 102. The elevation of the screed 122 may be indicative of a grade or thickness T of the mat 103 being laid on the paving surface 102. In an alternative embodiment, the first position parameter may only be a change in elevation of the screed 122 with respect to a predefined reference value.

Further, at step 504, a second position parameter of the screed assembly 120 is determined by the second sensor 404 positioned in proximity to the screed assembly 120. The second position parameter may be an inclination of the screed 122 with respect to the paving surface 102, transverse to the direction of paving. The inclination of the screed 122 is indicative of the slope S of the mat being laid on the paving surface 102. In an alternative embodiment, the second sensor 404 may only detect a change in inclination of the screed 122 with respect to a predefined reference value. In an exemplary embodiment, the second sensor 404 is a wireless slope sensor.

At step 506, the third transceiver 416 of the controller 406 wirelessly receives the determined first and second position parameters from the first transceiver 410 of the first sensor 402 and the second transceiver 414 of the second sensor 404, respectively. In an example, the first transceiver 410, the second transceiver 414 and the third transceiver 416 communicate wirelessly over one or more of wireless radio links, infrared communication links, short wavelength Ultra-high frequency radio waves, short-range high frequency waves, or the like.

As soon as the controller 406 receives the position parameters, it sends control signals to control the position of the screed assembly 120 based on the received position parameters, at step 508. For example, during operation, if the screed 122 starts to rise or fall, the controller 406 sends control signals to operate the tow arm cylinders 128 to raise or lower the screed 122 until the desired position of the screed 122 is achieved or reported by the first sensor 402. Similarly, if the inclination of the screed 122 changes, impacting the slope S of the mat 103, the controller 406 sends control signal to the tow arm cylinders 128 to adjust the inclination of the screed 122 until the desired inclination is achieved or reported by the second sensor.

It will be apparent to those skilled in the art that various modifications and variations can be made to the system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalent.

What is claimed is:

1. A control system for operating a screed assembly of a paving machine, the control system comprising:
a first sensor positioned in proximity to the screed assembly and configured to determine a first position parameter of the screed assembly, the first sensor including a first transceiver;
a second sensor positioned in proximity to the screed assembly and configured to determine a second position parameter of the screed assembly, the second sensor including a second transceiver; and
a controller including a third transceiver for wirelessly communicating with each of the first transceiver and the second transceiver to receive the first position parameter and the second position parameter, the controller being configured to control a position of the screed assembly based on one or more of the first position parameter and the second position parameter.

2. The control system of claim 1, wherein the first sensor is a wireless grade sensor for determining an elevation of the screed assembly with respect to a paving surface.

3. The control system of claim 1, wherein the controller is configured to adjust a height of the screed assembly based on the first position parameter received from the first transceiver of the first sensor.

4. The control system of claim 1, wherein the second sensor is a wireless slope sensor for determining an inclination of the screed assembly with respect to the paving surface.

5. The control system of claim 1, wherein the controller is configured to adjust an inclination of the screed assembly based on the second position parameter received from the second transceiver of the second sensor.

6. The control system of claim 1, wherein each of the first transceiver, the second transceiver and the third transceiver are configured to communicate wirelessly over one or more of wireless radio links, infrared communication links, short wavelength Ultra-high frequency radio waves, or short-range high frequency waves.

7. A method of operating a screed assembly of a paving machine, the method comprising:
determining, by a first sensor positioned in proximity to the screed assembly, a first position parameter of the screed assembly;
determining, by a second sensor positioned in proximity to the screed assembly, a second position parameter of the screed assembly;
receiving wirelessly, by a transceiver of a controller, one or more of the first position parameter from a first transceiver of the first sensor and the second position parameter from a second transceiver of the second sensor; and
controlling, by the controller, a position of the screed assembly based on one or more of the wirelessly received first position parameter and the second position parameter.

8. The method of claim 7, wherein the first sensor is a wireless grade sensor for determining an elevation of the screed assembly with respect to a paving surface.

9. The method of claim 7 further comprising adjusting a height of the screed assembly based on the first position parameter wirelessly received from the first transceiver of the first sensor.

10. The method of claim 7, wherein the second sensor is a wireless slope sensor for determining an inclination of the screed assembly with respect to the paving surface.

11. The method of claim 7 further comprising adjusting an inclination of the screed assembly based on the second position parameter received from the second transceiver of the second sensor.

12. The method of claim 7, wherein each of the transceiver of the controller, the first transceiver, and the second transceiver are configured to communicate wirelessly over one or more of wireless radio links, infrared communication links, short wavelength Ultra-high frequency radio waves, or short-range high frequency waves.

13. A paving machine comprising:
a screed assembly for spreading and compacting paving material over a paving surface;
a control system associated with the screed assembly, the control system including:
a first sensor positioned in proximity to the screed assembly, the first sensor including a first transceiver and configured to determine a first position parameter of the screed assembly;
a second sensor positioned in proximity to the screed assembly, the second sensor including a second transceiver and configured to determine a second position parameter of the screed assembly; and
a controller including a third transceiver configured to wirelessly communicate with each of the first transceiver and the second transceiver to receive the first position parameter and the second position parameter, the controller being configured to control a position of the screed assembly based on one or more of the received first position parameter and the second position parameter.

14. The paving machine of claim 13, wherein the first sensor is a wireless grade sensor for determining an elevation of the screed assembly with respect to the paving surface.

15. The paving machine of claim 13, wherein the controller is configured to adjust a height of the screed assembly based on the first position parameter received from the first transceiver of the first sensor.

16. The paving machine of claim 13, wherein the second sensor is a wireless slope sensor for determining an inclination of the screed assembly.

17. The paving machine of claim 13, wherein the controller is configured to adjust an inclination of the screed assembly based on the second position parameter received from the second transceiver of the second sensor.

18. The paving machine of claim 13, wherein each of the first transceiver, the second transceiver and the third transceiver are configured to communicate wirelessly over one or more of wireless radio links, infrared communication links, short wavelength Ultra-high frequency radio waves, or short-range high frequency waves.

19. The paving machine of claim 13, wherein the screed assembly includes a free-floating screed coupled to the paving machine via a tow arm, and wherein
the first sensor is positioned on the tow arm and the second sensor is positioned on the free-floating screed.
